(19) United States
(12) Patent Application Publication
(10) Pub. No.: US 2006/0183594 A1
(43) Pub. Date: Aug. 17, 2006

(54) Variable speed drive for a continuously variable transmission

(75) Inventors: Nicolae Souca, Baden-Baden (DE); Martin Vornehm, Buhl (DE)

Correspondence Address: ALFRED J MANGELS, 4729 CORNELL ROAD, CINCINNATI, OH, 452412433, US

(73) Assignee: LuK Lamellen und Kupplungsbau Beteiligungs KG, Buhl (DE)

(21) Appl. No.: 11/330,718

(22) Filed: Jan. 12, 2006

Related U.S. Application Data
(60) Provisional application No. 60/690,207, filed on Jun. 14, 2005.

(30) Foreign Application Priority Data
Jan. 15, 2005 (DE) 10 2005 001 975.7

(51) Int. Cl. F16H 15/42

(52) U.S. Cl. 476/52

(57) ABSTRACT

A friction ring variable speed drive with a continuously variable transmission ratio. A concavely curved first transmission element is rotatable around a first axis of rotation and a convexly curved second transmission element is rotatable around a second axis of rotation. The first and second transmission elements receive between them a segment of the circumference of a transmission ring. An adjusting device presses the transmission surfaces against the circumferential surfaces of the transmission ring for frictional transmission of torque between the transmission elements. The position of the transmission ring relative to the axes of rotation is variable by means of the adjusting device. A contact pressure device is provided for imposing a contact pressure between the transmission surfaces and the transmission ring, and the contact pressure increases as the transmitted torque increases.

### BACKGROUND OF THE INVENTION

1. Field of the Invention

The present invention relates to a variable speed drive for a continuously variable transmission. The function of the variable speed drive in such a transmission is to transmit the torque of an input shaft to an output shaft, with the transmission ratio between the input shaft and the output shaft being freely adjustable within a transmission ratio range.

2. Description of the Related Art

The use of chains or metal bands as endless torque-transmitting means in such variable speed drives is known, wherein they wrap around a conical disk pair that is connected to the input shaft and a conical disk pair that is connected to the output shaft. Such belt-driven conical-pulley transmissions are expensive to manufacture and require a relatively large space. Also known are variable speed drives for continuously variable transmissions (CVT) wherein the motion is transmitted between two toroidal surfaces by using an adjustable intermediate plate. The transmission of power requires high contact pressure forces, so that a number of intermediate plates are mounted between the toroidal plates, and/or a number of variable speed drives are used simultaneously. Also known are so-called conical ring variable speed drives, in which the torque is transmitted by means of a transmission ring between two opposed conical or tapered surfaces that are rotatable around two parallel axes of rotation.

An object of the present invention is to provide a variable speed drive for a continuously variable transmission that has a good spread of ratios and good torque transmitting capability, that requires little space, and that can be economically produced.

### SUMMARY OF THE INVENTION

The object of the invention is achieved with a variable speed drive for a continuously variable transmission that includes a first transmission element that is rotatable around a first axis of rotation and a second transmission element that is rotatable around a second axis of rotation. Each of the transmission elements has a concavely curved transmission surface that is rotationally symmetrical around its respective axis of rotation. The drive includes a rigid transmission ring with an outer and an inner circumferential surface, and a shifting device for the transmission ring, wherein the first and the second transmission elements are arranged in such a way that their transmission surfaces receive between them a segment of the circumference of the transmission ring and press the transmission surfaces against the circumferential surfaces for frictional transmission of torque between the transmission elements. The relative position of the transmission ring to the axes of rotation is variable by means of the shifting device, and a contact pressure device is provided by means of which the effective contact pressure between the transmission surfaces and the transmission ring increases as the transmitted torque increases.

With the pairing of a convex and a concave transmission surface provided in the variable speed drive in accordance with the invention, between which the transmission of torque occurs through frictional engagement with a rigid ring, a relatively good transmission ratio range is achieved in a compact space. The contact points of the transmission ring on the transmission surfaces do not move along a linear path during shifting, as in the case of a conical disc variable speed drive, but along a curved path, causing the ratios that determine the transmission ratio to change more severely than linear changes. The sphericity of the opposed frictionally engaged surfaces has a favorable influence on the torque transmitting capability. Furthermore, the production of noise that occurs in variable speed drives designed with wrapped chains is absent from the variable speed drive in accordance with the invention.

Advantageously, the axes of rotation of the transmission elements are parallel to each other, and the contact pressure device is designed so that as the torque increases it moves one of the transmission surfaces parallel to the corresponding axis of rotation increasingly in the direction of the other transmission surface.

Preferably, the transmission element formed with the movable transmission surface is torsionally engaged with a shaft of the friction ring variable speed drive through a roller and ramp mechanism, and the roller and ramp mechanism moves the transmission element increasingly in the axial direction as the torque increases. In that way a contact pressure device is created that operates purely mechanically, without interposition of, for example, a hydraulic system.

The above-identified contact pressure device is advantageously designed so that the shifting force is proportional to the torque.

The movable transmission element is advantageously torsionally engaged with a drive shaft of the variable speed drive.

Preferably, the movable transmission element has the concavely curved transmission surface.

Also advantageously, the axes of rotation of the transmission elements are parallel to each other, and two contact pressure devices are designed so that as the torque increases they move both transmission surfaces parallel to the corresponding axes of rotation increasingly in the direction of the other transmission surface. The two contact pressure devices each contain a roller and ramp mechanism, one of that is positioned on the drive shaft and the other on the output shaft. The two such mechanisms produce mutually opposed axial forces on the pair of conical disks. The greater of the two forces will move the conical disk pair to a stop, thereby determining the effective contact pressure force. In that way a contact pressure is produced that, at certain transmission ratios, is dependent on the transmission ratio, since the torque that causes the contact pressure depends upon the transmission ratio.

Advantageously, at the highest transmission ratio of the friction ring variable speed drive the effective contact pressure force is dominated by the contact pressure force on the output side, and the effective contact pressure force at the lowest transmission ratio of the friction ring variable speed drive is dominated by the contact pressure device on the drive side. The transition between drive side and output side determination of the effective contact pressure force occurs at a variable speed drive transmission ratio greater than 1.

The roller and ramp mechanism on the output side is advantageously designed so that it produces about 20-50% less contact pressure than the drive side roller and ramp mechanism at the same torque. That means that the roller and ramp mechanism on the output side is the dominating determinant of the contact pressure only at transmission ratios greater than 1.3 to 2.0. At transmission ratios lower than 1.3 to 2.0, the drive side roller and ramp mechanism dominates the contact pressure.

The angle that the transmission surfaces form with the corresponding axis of rotation preferably varies from a mean angle by more than 10% and less than 50%. That angle limits the adjustability of the transmission ring.

In a preferred form of the friction ring variable speed drive, the line of intersection between the concavely curved transmission surface and a plane extending between the axes of rotation forms at least one of a plurality of circular arc segments whose radii are 3 to 10 times the distance between the axes of rotation. The centers of the circular arc segments are spaced from the corresponding axis of rotation by 2 to 9 times the distance between the axes of rotation, and are offset from the transmission surface by 1 to 4 times the distance between the axes of rotation.

The outer surface of the transmission ring advantageously has a spherical shape whose radius is 0.4 to 1.5 times the distance between the axes of rotation.

In one version of the variable speed drive in accordance with the invention, the lines of intersection of the transmission surfaces with the plane extending between the axes of rotation are segments of ellipses.

Preferably, the lines of intersection of the transmission surfaces with the plane stretched between the axes of rotation are at a constant distance from each other within the range of adjustment of the transmission ring, corresponding to the radial thickness of the ring.

Also advantageous is a design of the transmission ring such that the outer circumferential surface of the transmission ring is curved in conformity with the concave transmission surface, so that it closely nestles against the latter.

The shifting apparatus can contain a support through which the transmission ring circulates. The support determines the angle between the line of intersection of the ring plane with the plane of the axes of rotation and the axes of rotation.

The support can be rotatable around an axis that is, for example, coaxial with a diameter of the transmission rings, and that is perpendicular to the plane stretched between the axes of rotation.

A frictional transmission in accordance with the invention contains one or more of the variable speed drives described above.

A motor vehicle in accordance with the invention is equipped with a frictional transmission as described above.

### BRIEF DESCRIPTION OF THE DRAWINGS

The structure, operation, and advantages of the present invention will become further apparent upon consideration of the following description, taken in conjunction with the accompanying drawings in which:

FIG. 1 is a cross-sectional view of a first embodiment of a variable speed drive;

FIG. 2 is a cross-sectional view of a second embodiment of a variable speed drive;

FIGS. 3 to 5 are schematic side views to illustrate the functioning and advantages of a variable speed drive in accordance with the invention,

FIGS. 6 and 7 are schematic side views of a conical friction variable speed drive having two contact pressure devices in the form of ball and ramp mechanisms; and

FIG. 8 is a graph showing the contact pressure requirement of an advantageous friction ring variable speed drive and of the contact pressure achieved with two ball and ramp mechanisms.

### DESCRIPTION OF THE PREFERRED EMBODIMENTS

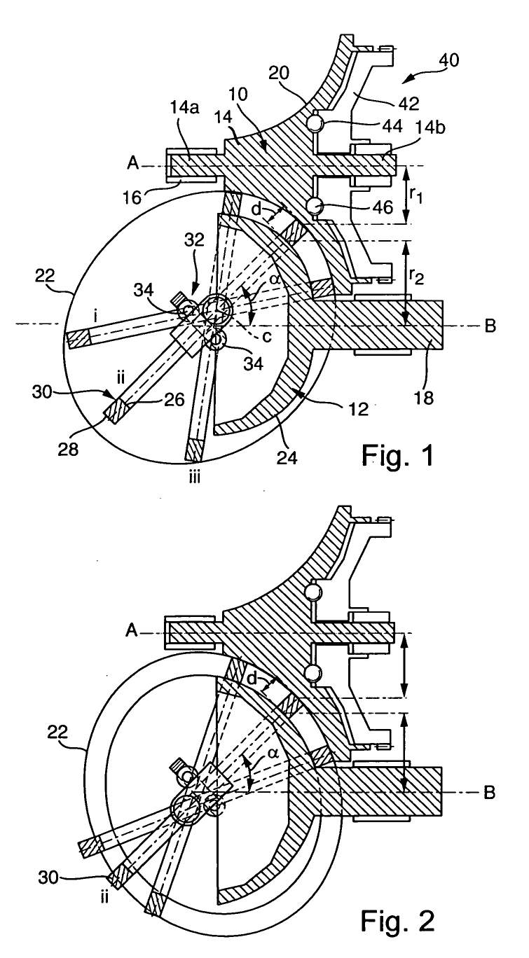

FIG. 1 shows a longitudinal cross-sectional view through a variable speed drive in a plane that contains two parallel axes of rotation A and B of two transmission elements 10 and 12. Transmission element 10 has stub shafts 14a and 14b that are mounted in a transmission case 16 and that form the driven or input shaft 14 of the variable speed drive.

Transmission element 12 has a shaft 18 that is mounted in the transmission case and forms the output shaft of the variable speed drive.

Transmission element 10 is designed with a concavely curved transmission surface 20, whose profile line in the example shown is part of an ellipse 22.

Transmission element 12 is designed with a convex transmission surface 24 that is also part of an ellipse.

As can be seen from FIG. 1, transmission surfaces 20 and 24, that are rotationally symmetrical around their respective axes, are positioned in such a way that the areas of the transmission surfaces that face each other are at a constant distance from each other and extend over a circumferential angle range of approximately 90° (measured in the cutting plane). That constant distance corresponds approximately to the radial thickness d of a rigid transmission ring 30 whose inner circumferential surface 26 and outer circumferential surface 28 are in contact with and pressed against the respective transmission surfaces 24, 20.

The transmission ring 30 that brings about the transmission of torque between transmission element 10 and transmission element 12 is shown in FIG. 1 in three different positions. Position ii of the diameter of transmission ring 30 that lies in the cutting plane forms an angle α with the rotation axes A or B. Positions i and iii, respectively, define the greatest and smallest transmission ratios of the variable speed drive. The middle position ii defines a middle position of the variable speed drive, in that in the example shown the plane of transmission ring 30 contains the major axis of the ellipse 22.

The particular kinematic or operative transmission ratio radius of transmission element 10 is designated by r₁. The particular operative radius of transmission element 12 is designated by r₂.

The rotational speed ω₁ of input shaft 14 and the rotational speed ω₂ of output shaft 18 are governed approximately by the following equation:

An adjusting device is provided for adjusting the angle α and includes a support or holder 32 that has, for example, two rollers 34 attached to a frame, between which the side surfaces of transmission ring 30 run. To adjust the angle α, holder 32 can be rotated by means of a drive (not shown) about an axis C, for example, that in accordance with FIG. 1 is perpendicular to the cutting plane and approximately forms a diameter of transmission ring 28. When transmission ring 28 is pivoted about axis C, holder 32 directly predetermines the angle a for transmission ring 28, whereby the positions of the outer and inner contact points between the ring and the transmission surfaces are changed directly. Alternatively, transmission ring 28 can also be pivoted with holder 32 around an axis that corresponds to a diameter of transmission ring 28 lying in the cutting plane. With that pivoting or tilting, transmission ring 28 spirals its own way along the transmission surfaces and attains a new angle α as the ultimate value of the spiraling motion.

Holder 32 can also be designed so that it is pivoted around an offset axis, or merely displaced, by means of the drive (not shown). The contact between transmission ring 28 and the transmission surfaces then takes place at different positions on the crowned circumferential or outer surfaces of the transmission ring, which reduces the demand on the surfaces.

In order to ensure the necessary contact pressure between the surface areas of transmission ring 30 and transmission surfaces 20 and 24 of transmission elements 10 and 12 for transmission of torque, transmission element 10 is connected through a contact pressure device that is designated in its entirety as 40, to a drive shaft, not shown, that is driven by a drive motor. Contact pressure device 40 contains a part 42 that is mounted coaxially with input shaft 14 and is rigidly connected to an axially immovable drive shaft (not shown). Between contact pressure device 40 and a surface of transmission element 10 that faces it are beveled or ramped surfaces 44, that are spaced from each other by roller elements 4. As the operating torque increases, part 42 thus twists increasingly relative to transmission element 10, so that because of the roller elements 46 running on the ramped surfaces 44 the distance between transmission element 10 and part 42 becomes larger, and transmission element 10, which is mounted so that it is axially movable, is forced into closer and closer contact with transmission ring 30. The angle of the ramped surfaces relative to a plane perpendicular to axis of rotation A determines the transmission ratio between the increasing torque and the increasing force with which transmission element 10 is displaced to the left in accordance with FIG. 1. With the angle constant there is a proportionality between the axial force exerted on transmission element 10 and the torque.

FIG. 2 shows an embodiment of a friction ring variable speed drive that is similar to the one shown in FIG. 1, with the single exception that the positions of the major and minor axes of ellipse 22 are interchanged; that is, in position ii of transmission ring 30 in FIG. 2 the minor axis of the ellipse is approximately in the plane of transmission ring 30. As can be seen, with the same spread of the variable speed drive the adjustable angle α is smaller in the embodiment in accordance with FIG. 2 than in the embodiment in accordance with FIG. 1. For the sake of simplicity, additional reference numerals are not shown in FIG. 2. As can be seen from FIGS. 1 and 2, the ellipses that form the generators of the transmission surfaces are at a constant distance from each other, that distance corresponding approximately to the thickness d of transmission ring 30.

The transmission surfaces 20, 24 can also have other than an ellipsoidal shape, for example the shape of any other conic section, such as a hyperboloid or a sphere. The contact pressure device, which advantageously detects the effective torque, can also be made in a different way; for example it can operate with hydraulic cylinders. The contact pressure device shown that operates purely mechanically is especially simple in its construction. Even with a contact pressure device that operates purely mechanically, without incorporating hydraulic transmission elements, additional simple components, such as Belleville springs, can be used for a basic contact pressure.

In the following section, certain features of the described friction ring variable speed drive will be explained; the transmission surfaces 20, 24 do not necessarily have an elliptical contour.

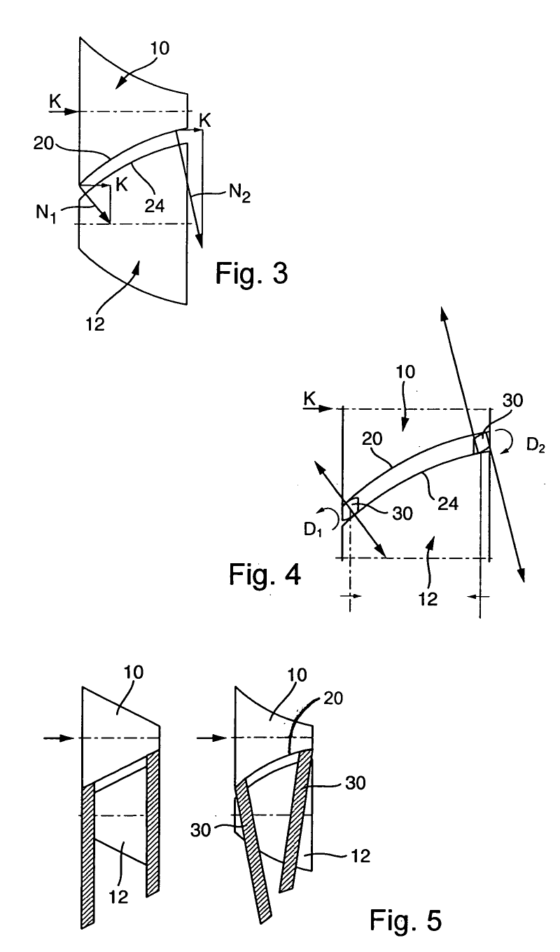

FIG. 3 shows how an axial force K acting from transmission element 10 (the depiction is reversed from FIGS. 1 and 2) results in different normal forces N₁, N₂, that are approximately perpendicular to the transmission surfaces, depending upon the angle of inclination of the transmission surfaces. The greater the angle between the tangent to the transmission surface and the axis of rotation, the greater the effective axial force in proportion to the normal force. It can also be seen from FIG. 3 that the transmission ring (not shown) transmits both the axial force K that tends to tilt the ring, and the normal force N that results in the contact pressure, as a result of which a frictional engagement and hence a transmission of torque is possible. As can be seen from FIG. 3, the unit operates with a flatter contour and hence with a greater contact pressure force in underdrive than in overdrive. That helps the torque transmission reliability of the variable speed drive.

FIG. 4 shows how, when there is a large inclination between transmission surfaces 20 and 24 and the axial direction, the crowned shape of the outer surfaces of transmission ring 30 results in an effective torque D₁ that acts on transmission ring 30, and that attempts to rotate transmission ring 30 counterclockwise, while on the other hand at a small angle of inclination a torque D₂ arises that attempts to rotate transmission ring 30 clockwise.

FIG. 5 illustrates the advantages achieved with the version of transmission elements 10 and 12 and of transmission ring 30 in accordance with FIG. 4, compared to a non-crowned design.

In the left part of FIG. 5 the transmission surfaces of transmission elements 10 and 12 are in the form of conical surfaces, that are curved only perpendicular to the drawing plane. The right part of FIG. 5 shows the crowned shape, in that the transmission surfaces are also curved in their cross section in the drawing plane, while the concavely curved transmission surface 20 of transmission element 10 is the driven transmission surface. As can be seen, the tilting of transmission ring 30 explained on the basis of FIG. 4 results in the space savings indicated by the cross-hatching.

To achieve a contact pressure that is independent of the transmission ratio and dependent only on the torque, a curved contour is advantageous whose radius is 4.7 times the distance between axes A and B (FIG. 1), the center point being at a spacing of 3.9 times. The contact pressure device with the described roller element and ramp mechanism is advantageously located on the transmission element with the concave transmission surface, because there the contact pressure device is exposed only to the torques and speeds of the drive motor, that generally vary less severely.

In order to be able to transmit higher drive torques, a plurality of the described friction ring variable speed drives can be used in parallel, or a plurality of variable speed drives each having a narrower spread can be used in series to achieve a greater spread.

Friction ring variable speed drives in which the angle that the transmission surfaces form with the associated axis of rotation varies from a mean angle by more than 10% and less than 50% have generally proven themselves. The adjustment range of the transmission ring is such that that angular range of the transmission surfaces is used.

When the generators of the curvature of the transmission surfaces are circular, the intersection line between the concavely curved transmission surface and a plane passing through the axes of rotation forms at least one of circular segments whose radii are preferably 3 to 10 times the distance between the axes of rotation. The center points of the circular arc segments advantageously are distant from the corresponding axis of rotation by between 2 and 9 times the distance between the axes of rotation, and are axially offset from the transmission surface by about 1 to 4 times the distance between the axes of rotation.

The crowning of the outer surface of the transmission ring is then, for example, 0.4 to 1.5 times the distance between the axes of rotation.

Compared to a friction ring variable speed drive having merely conical transmission elements, i.e., those having surfaces that intersect the drawing plane with straight lines, friction ring variable speed drives having transmission surfaces that are arched in both primary planes result in the following advantages, among others.

In the frequently used overdrive range the contact pressure force is lower. The low maximum and transmission-ratio-independent axial forces allow economical designs that contain only the described, purely mechanically operating, ball or roller-element/ramp mechanism and manage without hydraulics. The low forces result in further efficiency advantages, for example from lower rolling losses in the frictional contacts or in the bearings of the shafts.

The use of hyperboloid transmission surfaces means, for example, that in underdrive the contour has a large radius of curvature of 1.4 m for example, whereas in overdrive the radius of curvature is only 0.4 m. The small radius of curvature in overdrive is advantageous, because as a result the contact region (pressing ellipse) there remains small. A small pressing ellipse promotes good efficiency in overdrive.

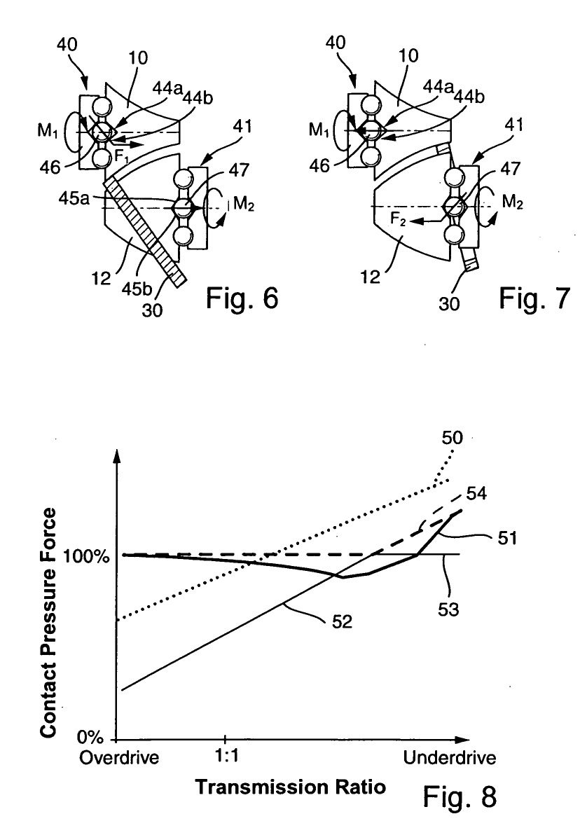

FIG. 6 shows a cross section through a concave-convex friction ring variable speed drive with a contact pressure device 40 having two ball and ramp mechanisms, one on the drive side transmission element 10 and one on the output-side transmission element 12.

Transmission ring 30 is positioned so that the transmission ratio of the friction ring variable speed drive is less than one, which means that a torque M₁ introduced into transmission element 10 by the drive-side contact pressure device 40 is changed to a lower output torque M₂ at the output-side contact pressure device 41.

The axial force F₁ produced by contact pressure device 40 through roller elements 46 and ramps 44b acts on contact pressure device 41 through transmission ring 30, which, because of the low torque and because of its design, is displaced so far that roller elements 47 rest not on only one of the ramps 45a or 45b, but on both ramps 45a and 45b.

The axial force F₁ thus produced by contact pressure device 40 is sufficient to ensure transmission of the tractive force at the transmission ratio shown, which would not be the case if the effective axial force were determined by contact pressure device 41.

FIG. 7 shows the same friction ring transmission as shown in FIG. 6, but herein which the transmission ring 30 is positioned so that the transmission ratio of the friction ring variable speed drive is significantly greater than one.

In that case the torque M₂ is great enough to shift the roller elements 47 onto one of the ramps 45a or 45b, and at the same time to produce a large axial force F₂. That is large axial force F₂ is sufficiently high to enable the transfer of the tractive force at that transmission ratio.

FIG. 8 shows the axial contact pressure force needed required at a defined input torque as a curve 51 extending over the transmission ratio range of the friction ring variable speed drive.

With the advantageous concave-convex configuration of the conical contours, that requirement represents a curve that can be characterized as “constant over broad transmission ratio ranges” and “only rising sharply in the vicinity of the highest transmission ratio.” That contact pressure requirement is determined by the need for constantly low slippage of 2%, for example, at the frictional contacts.

The concave-convex contour of transmission elements 10 and 12 enables a transmission-ratio-dependent effect of the axial contact pressure through the different angles between the axial force and the contact force. For that reason, the requirement for maximum contact pressure force is reduced in underdrive.

The concave-convex contour also enables a transmission-ratio-dependent boring motion to the frictional contacts, which boring motion changes the friction value that is effective for transmitting tractive force. For that reason, the contact pressure requirement is increased in overdrive.

For comparison, the course 50 of the required axial force of a conventional straight-sided conical friction ring variable speed drive is shown by a dotted line 50. That line 50 is clearly different from the curve 51.

The dashed line 54 represents the actually generated contact pressure force of the contact pressure device in accordance with the invention, and that includes two advantageous ball and ramp mechanisms. At all transmission ratios, that actually generated contact pressure force is only slightly higher than the contact pressure requirement curve 51 of the concave-convex friction ring variable speed drive, which reflects the necessary security against slipping. Since the efficiency of frictional transmissions decreases the more the actual contact pressure exceeds the necessary contact pressure, the combination of a concave-convex friction ring variable speed drive with a contact pressure device including two ball and ramp mechanisms offers high efficiency.

Although particular embodiments of the present invention have been illustrated and described, it will be apparent to those skilled in the art that various changes and modifications can be made without departing from the spirit of the present invention. It is therefore intended to encompass within the appended claims all such changes and modifications that fall within the scope of the present invention.

What is claimed is:

1. A friction ring variable speed drive having a continuously variable transmission ratio, said drive comprising:
a first transmission element rotatable about a first axis of rotation and having a concavely curved transmission surface that is rotationally symmetrical about the first axis of rotation;
a second transmission element rotatable about a second axis of rotation and having a convexly curved transmission surface that is rotationally symmetrical about the second axis of rotation;
a rigid transmission ring having an outer circumferential surface and an inner circumferential surface and positioned between the first and second transmission elements;
an adjusting device for shifting a position of the transmission ring relative to the axes of rotation of the transmission elements;
wherein the first and the second transmission elements are arranged so that their transmission surfaces receive between them a circumferential segment of the transmission ring and press the transmission surfaces against the circumferential surfaces of the transmission ring for frictionally engaged transmission of torque between the transmission elements; and
a contact pressure device that is operative so that an effective contact pressure force between the transmission surfaces and the transmission ring increases as a transmitted torque increases.

2. A friction ring variable speed drive in accordance with claim 1, wherein the axes of rotation of the transmission elements are parallel to each other and the contact pressure device shifts one of the transmission surfaces parallel to its axis of rotation in the direction of the other transmission surface as the torque increases.

3. A friction ring variable speed drive in accordance with claim 2, wherein the transmission element having the shifted transmission surface is torsionally engaged with a shaft of the friction ring variable speed drive through a roller and ramp mechanism, and the roller and ramp mechanism moves the transmission element in an axial direction as the torque increases.

4. A friction ring variable speed drive in accordance with claim 3, wherein the contact pressure force applied by the contact pressure device is proportional to the torque.

5. A friction ring variable speed drive in accordance with claim 3, wherein the transmission surface shifted by the contact pressure device is torsionally engaged with a drive shaft of the variable speed drive.

6. A friction ring variable speed drive in accordance with claim 3, wherein the shifted transmission surface is that of the first transmission element.

7. A friction ring variable speed drive in accordance with claim 1, wherein the axes of rotation of the transmission elements are parallel to each other, and wherein each of the transmission elements includes a contact pressure device, so that as the torque increases the contact pressure devices shift each respective transmission surface parallel to its axis of rotation and toward an opposed transmission surface.

8. A friction ring variable speed drive in accordance with claim 7, wherein:
at a highest transmission ratio of the friction ring variable speed drive an effective contact pressure force is dominated by the contact pressure device on an output side;
at a lowest transmission ratio of the friction ring variable speed drive the effective contact pressure force is dominated by the contact pressure device on the drive side; and
wherein a transition between drive side and output side determination of the effective contact pressure force occurs at a variable speed drive transmission ratio greater than 1.

9. A friction ring variable speed drive in accordance with claim 1, wherein an angle formed by the transmission surfaces with their corresponding axes of rotation varies by more than 10% and less than 50% from a mean angle.

10. A friction ring variable speed drive in accordance with claim 1, wherein a line of intersection between the concavely curved transmission surface and a plane passing through the axes of rotation of the transmission elements forms at least one of a plurality of circular arc segments whose radii are 3 to 10 times a distance between the axes of rotation, and whose centers are spaced from the axis of rotation of the first transmission element by 2 to 9 times the distance between the axes of rotation, and whose centers are offset from the first transmission element transmission surface by 1 to 4 times the distance between the axes of rotation.

11. A friction ring variable speed drive in accordance with claim 10, wherein an outer surface of the transmission ring has a spherical shape whose radius is 0.4 to 1.5 times the distance between the axes of rotation.

12. A friction ring variable speed drive in accordance with claim 1, wherein lines of intersection of the transmission surfaces with a plane passing through the axes of rotation are segments of ellipses.

13. A friction ring variable speed drive in accordance with claim 12, wherein when the transmission ring is approximately at a midpoint of its shifting range the major axis of an ellipse is in the plane of the ring.

14. A friction ring variable speed drive in accordance with claim 13, wherein when the transmission ring is approximately at a midpoint of its shifting range the minor axis of an ellipse is in the plane of the ring.

15. A friction ring variable speed drive in accordance with claim 1, wherein within a shifting range of the transmission ring lines of intersection of the transmission surfaces with a plane passing through the axes of rotation are at a constant distance from each other corresponding to a radial thickness of the ring.

16. A friction ring variable speed drive in accordance with claim 1, wherein the adjusting device includes a support through which the transmission ring passes, wherein the support determines an angle between a line of intersection of a ring plane with a plane containing the axes of rotation.

17. A friction ring variable speed drive in accordance with claim 16, wherein the support is rotatable about an axis that is coaxial with a diameter of the transmission ring and is perpendicular to a plane passing through the axes of rotation.

18. A friction ring variable speed drive in accordance with claim 16, wherein the support is rotatable about an axis that is coaxial with a diameter of the transmission ring and lies in a plane passing through the axes of rotation.

19. A frictional transmission including more than one friction ring variable speed drives in accordance with claim 1.

20. A motor vehicle including a frictional transmission in accordance with claim 1.
